(19) United States
(12) Patent Application Publication
(10) Pub. No.: US 2015/0329022 A1
(43) Pub. Date: Nov. 19, 2015

(54) HOLDER FOR HEADREST

(71) Applicants: Masato MIYAGUCHI, Farmington Hills, MI (US); Hisayuki YOSHIZAWA, Farmington Hills, MI (US)

(72) Inventors: Masato MIYAGUCHI, Farmington Hills, MI (US); Hisayuki YOSHIZAWA, Farmington Hills, MI (US)

(21) Appl. No.: 14/276,275

(22) Filed: May 13, 2014

(51) Int. Cl. B60N 2/48

(52) U.S. Cl. CPC B60N 2/4808; B60N 2002/4897

(57) ABSTRACT

To provide a headrest holder capable of preventing a wobble of a headrest and generating of a rattle. A headrest holder includes a main body loaded in a support bracket provided on a top portion of a seat back of a vehicle as well as provided with a stay insertion hole for inserting a stay of a headrest, in which the main body is integrally provided with an elastic tongue piece hanging downward, a free end portion of which protrudes into the stay insertion hole, an outer surface on a base end side of the tongue portion has a contact area making a surface contact with an inner wall surface of the support bracket, and the main body is loaded inside the support bracket so that the free end side of the tongue portion is separated from the inner wall surface of the support bracket.

### BACKGROUND OF THE INVENTION

1. Field of the Invention

The present invention relates to a holder supporting a headrest or a so-called a headrest stay. The headrest is attached on a top portion of a seat back in a vehicle seat by the holder so as to be a support. The holder itself is supported at a top portion of a seat back frame, into which a stay of the headrest (or a headrest stay) is inserted, which exists there for fixing the headrest on the seat back. The present invention particularly relates to a headrest holder(holder for headrest)capable of efficiently preventing a wobble and a rattle not only in the headrest holder inside a support bracket fixed to the top portion of the seat back frame but also in the headrest stay.

2. Description of Related Art

Generally, the headrest holder includes a head portion and a cylindrical portion extending therefrom, in which the cylindrical portion is formed so that a headrest stay is inserted into the portion to support the stay.

As one of the conventional problems which have been found in the headrest holder, the wobble and the rattle tend to occur in the headrest stay as a clearance exists between an outer surface of the headrest stay and an inner surface of the headrest holder even when the headrest stay is firmly supported by the headrest holder. Similarly, the wobble and the rattle tend to occur in the headrest holder itself as a clearance exist between an outer surface of the headrest holder and an inner surface of the support bracket even when the support bracket fixed to the seat back frame is firmly fitted.

A measure for solving the above problems is disclosed in, for example, JP-A-11-89665, in which a headrest holder having elastic pressing parts fixed to a cylindrical portion is proposed, which is formed so that respective pressing parts apply the pressure to the inside of the cylindrical portion. According to JP-A-11-89665, the first and second pairs of pressing parts are formed in the cylindrical portion so as to face each other in the same level. Therefore, a headrest stay is inserted into the cylindrical portion of the headrest holder and the first and second pairs of pressing parts contact surfaces of the headrest stay which are opposite to each other to press the stay. Accordingly, the pressure is applied there, and the headrest stay is fixed between the pressing parts. More specifically, respective pressing parts are formed with protrusions existing in inner surfaces, and are also formed with concave portions at points corresponding to the protrusions also on outer surfaces. The protrusion has a substantially arc shape in cross section, which protrudes from the inner surface of the headrest holder toward the central direction of the axis thereof. On the other hand, the concave portion on the opposite side of the convex portion forms two sharp protrusions, which protrude outside from the outer surface of the headrest holder.

The headrest holder formed as described above is first fitted to a support bracket fixed to a seat back frame before the headrest stay is inserted into the headrest holder. When the headrest stay is inserted into the headrest holder, the outer surface of the headrest stay presses all the protrusions of the pressing parts, and all the two sharp protrusions in the concave portions of the pressing parts contact and press the inner surface of the support bracket. Under such state, all the pressing parts apply the pressure to both of the headrest stay and the support bracket, as a result, the headrest stay is supported inside the headrest holder, meanwhile, the headrest holder is supported by the support bracket. This arrangement seemingly prevents the above-described wobble and the rattle to be generated between the headrest stay and the headrest holder.

However, in the above art, all the pressing parts are collectively arranged at one place of the body portion of the headrest holder in the same level. Accordingly, when the headrest stay is inserted into the headrest holder, the pressure is added from the pressing parts to one place of the headrest stay in a concentrated manner, and the headrest stay is inclined with respect to the pressing parts in a hole inside the body portion of the headrest holder. That is because the pressing parts give just one support point in the headrest stay as a whole. Consequently, it is highly likely that the headrest stay wobbles inside the headrest holder or that the rattle is generated there. Furthermore, the arrangement of respective pressing parts, that is, arc-shaped protrusions and concave portions of the pressing parts are extremely complicated, which requires high technical capability for forming the headrest holder and which leads to further cost increase. The first pair of pressing parts and the second pair of pressing parts are respectively arranged at an upper portion and a lower portion of the cylindrical portion of the holder for preventing occurrence of the wobble of the headrest stay in the headrest holder and generation of the rattle. However, the arrangement of the headrest holder makes the structure complicated, which increases costs and requires technical skills.

### SUMMARY OF THE INVENTION

An object of the present invention is to provide a headrest holder capable of preventing a wobble of a headrest and generating of a rattle.

According to an embodiment of the present invention, there is provided a headrest holder including a main body loaded in a support bracket provided on a top portion of a seat back of a vehicle as well as provided with a stay insertion hole for inserting a stay of a headrest, in which the main body is integrally provided with an elastic tongue piece hanging downward, a free end portion of which protrudes into the stay insertion hole, an outer surface on a base end side of the tongue piece has a contact area making a surface contact with an inner wall surface of the support bracket, and the main body is loaded inside the support bracket so that the free end side of the tongue piece is separated from the inner wall surface of the support bracket.

In the headrest holder, the tongue piece is elastically pressed onto the outer surface of the stay when the stay of the headrest is inserted into the stay insertion hole formed in the main body, therefore, the wobble of the stay of the headrest and generation of the rattle can be prevented. Additionally, the outer surface on the base end side of the tongue piece has the contact area making the surface contact with the inner wall surface of the support bracket, therefore, the bending stress generated on the base end side of the tongue piece when the tongue piece is elastically pressed to the outer surface of the stay can be dispersed by the contact area, which prevents stress concentration to the base end side of the tongue piece. There is a danger that the elasticity of the tongue piece is reduced and is finally broken when the stress is concentrated, however, the durability of the tongue piece required when the stay of the headrest is inserted into and pulled out from the headrest holder can be also increased according to the present invention.

It is preferable that the tongue piece is arranged on the rear side of the vehicle in a circumferential direction of the main body.

As a load applied rearward is generated in the headrest when used, it is possible to keep the tongue piece being pressed onto the stay positively while using the headrest by arranging the tongue on the rear side of the vehicle.

It is also preferable that a plural number of tongue pieces are formed in the main body in an extending direction of the stay insertion hole.

It is possible to positively prevent the stay of the headrest from falling off as well as from rotating when the above structure is applied.

It is also preferable that a stay abutting surface having a curved shape fitted to an outer peripheral surface of the stay is formed in the free end portion of the tongue piece.

As the outer peripheral surface of the stay is allowed to abut on the stay abutting surface uniformly by applying the above structure, the contact area of the tongue piece can abut on the inner wall surface of the support bracket uniformly, which prevents stress concentration.

It is also preferable that a notch portion for allowing the tongue piece to protrude into the stay insertion hole is formed in the main body.

It is also preferable that the support bracket is provided with a holder loading hole for loading the main body, the inner wall surface forming the holder loading hole has a rectangular shape in cross section, and the contact area is formed as a flat surface for making the surface contact with the inner wall surface.

It is also preferable that the tongue piece is made of resin and can be elastically deformed around the base end side of the tongue piece in a state in which the contact area abuts on the inner wall surface of the support bracket.

It is also preferable that a lock piece to be locked in the support bracket is provided in a lower end of the main body.

It is also preferable that ribs which are allowed to abut on the inner wall surface of the support bracket are extended in a circumferential direction on the outer wall surface of the main body, and a plural number of ribs are formed in the main body in an extending direction of the stay insertion hole.

Other various features and advantages will be become apparent from reading of the description, hereinafter, with reference to the accompanied drawings.

### BRIEF DESCRIPTION OF THE DRAWINGS

FIG. 1 is a perspective view showing a headrest holder according to an embodiment of the present invention;

FIG. 2 is a perspective view showing the headrest holder;

FIG. 3 is a side view showing a tongue piece applied to the headrest holder;

FIG. 4 is a front view of the tongue piece;

FIG. 5 is a cross-sectional view of the tongue piece;

FIG. 6 is a cross-sectional view showing a state in which the tongue piece is elastically deformed by a stay;

FIG. 7 is a cross-sectional view taken along A-A line of FIG. 6; and

FIG. 8 is a cross-sectional view taken along B-B line of FIG. 6.

### DETAILED DESCRIPTION OF THE INVENTION

Hereinafter, a preferred embodiment of a headrest holder according to the present invention will be explained in detail with reference to the drawings.

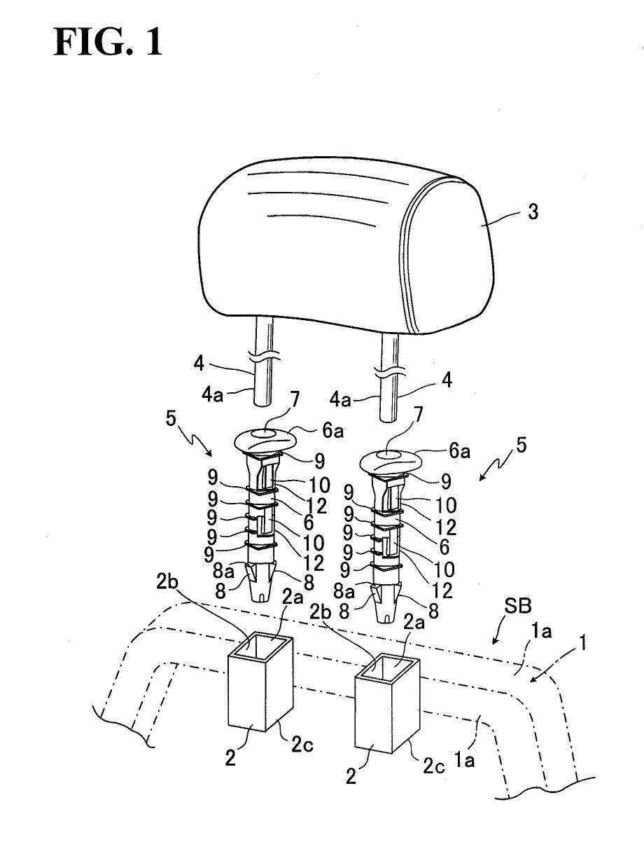

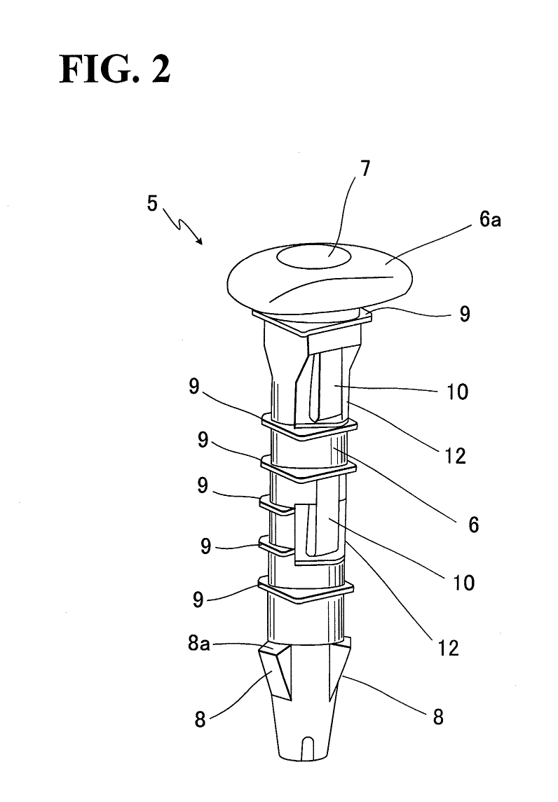

As shown in FIG. 1 and FIG. 2, a seatback frame 1 is provided inside a seatback SB of a vehicle. In a horizontal beam la of the seatback frame 1, metallic support brackets 2 are fixed by welding. The support brackets 2 having a square cylindrical shape are arranged on a top portion of the seatback SB, and holder loading holes 2a for loading headrest holders 5 made of resin are formed in the support brackets 2.

A right and left pair of stays 4 are provided in a head rest 3. The stays 4 are fixed to the seatback frame 1 through the headrest holders 5 and the support brackets 2. Each headrest holder 5 is provided with a cylindrical main body 6, and a flange-shaped head 6a exposed from the seat back SB is provided in a top portion of the main body 6.

The main body 6 is provided with a stay insertion hole 7 for inserting the stay 4 of the headrest 3. On an outer wall surface 6b of the main body 6, ribs 9 which are allowed to abut on an inner wall surface 2b of the support bracket 2 are extended in a circumferential direction of the main body 6. A plural number of (for example, six) ribs 9 are formed in the main body 6 in an extending direction of the stay insertion hole 7, namely, an axis-line L direction of the main body 6.

In a lower end of the main body 6, lock pieces 8 to be locked in a lower end 2c of the support bracket 2 are provided. The lock piece 8 is formed in an L-shape in cross section, which is widened upward. A lock surface 8a to be locked in the lower end 2c of the support bracket 2 is provided in an upper portion of the lock piece 8.

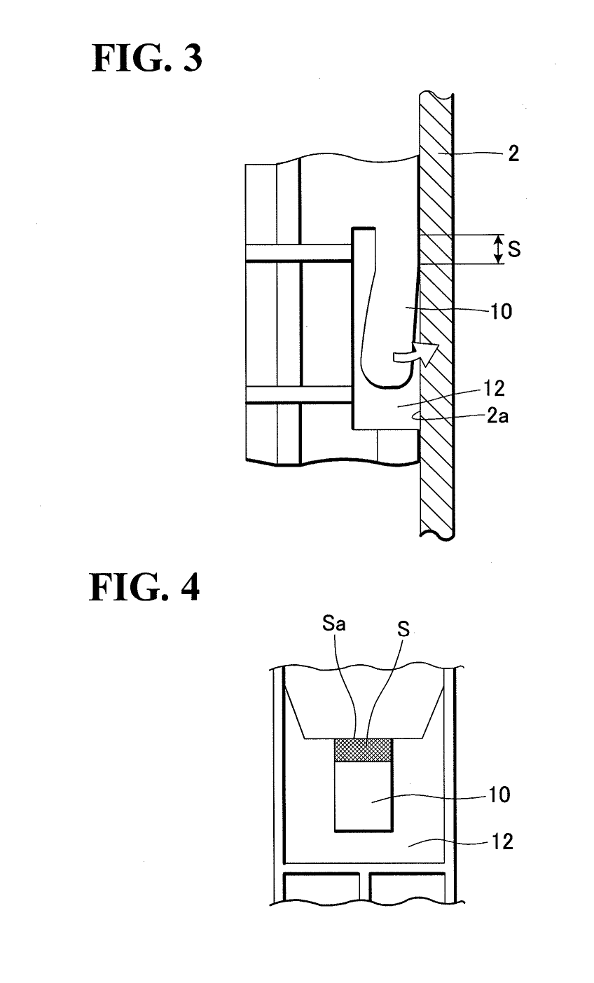

As shown in FIG. 3 to FIG. 5, an elastic tongue piece hanging downward, a free end portion 10b of which protrudes into the stay insertion hole 7 is integrally provided in the main body 6. As the main body 6 is made of resin such as polypropylene, the tongue piece 10 integrally formed with the main body 6 has elasticity. Then, the tongue piece 10 can be elastically deformed around a base end side of the tongue piece 10 in a state in which a contact area S abuts on the inner wall surface 2b of the support bracket 2.

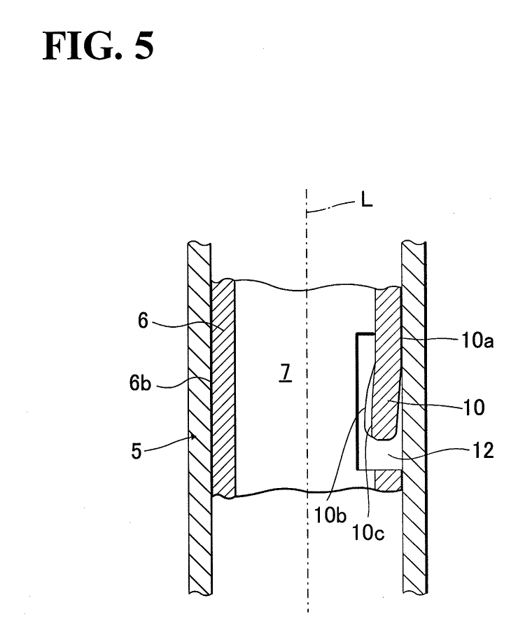

An outer surface 10a on the base end side of the tongue piece 10 has the contact area S making a surface contact with the inner wall surface 2b of the support bracket 2. The free end portion 10b side of the tongue piece 10 is separated from the inner wall surface 2b of the support bracket 2 in a state in which the headrest holder 5 is loaded in the support bracket 2 (refer to FIG. 3 and FIG. 5).

The tongue piece 10 is arranged on the rear side of the vehicle in the circumferential direction of the main body 6. As a load applied rearward is generated in the headrest 3 when used, it is possible to keep the tongue piece 10 being pressed onto the stay 4 positively while using the headrest 3 by arranging the tongue piece 10 on the rear side of the vehicle.

A plural number of (for example, two) tongue pieces 10 are formed in the main body 6 in the extending direction of the stay insertion hole 7 (refer to FIG. 2). It is possible to positively prevent the stay 4 of the headrest 3 from falling off as well as from rotating when the above structure is applied.

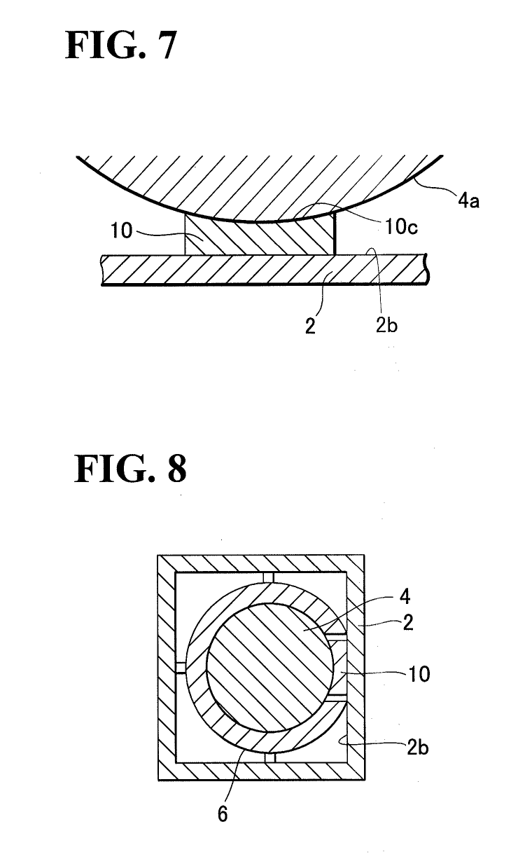

In the free end portion 10b of the tongue piece 10, a stay abutting surface 10c having a curved shape fitted to an outer peripheral surface 4a of the cylindrical stay 4 is formed (refer to FIG. 7). As the outer peripheral surface 4a of the cylindrical stay 4 is allowed to abut on the stay abutting surface 10c uniformly by applying the above structure, the contact area S of the tongue piece 10 can abut on the inner wall surface 2b of the support bracket 2 uniformly, which prevents stress concentration.

The holder loading hole 2a for loading the main body 6 is provided in the support bracket 2, and the inner wall surface 2b forming the holder loading hole 2a has a rectangular shape in cross section. The contact area S is formed as a flat surface for making the surface contact with the inner wall surface 2b. A free end portion of the rib 9 extends in a straight line to contact the inner wall surface 2b.

A notch portion 12 for allowing the tongue piece 10 to protrude into the stay insertion hole 7 is formed in the main body 6. The notch portion 12 is formed as a rectangular opening. The tongue piece 10 hangs downward so as to be seen from the notch portion 12. A base end of the tongue piece 10 is positioned so as to block part of an outline of the notch portion 12. Accordingly, an upper edge Sa of the rectangular contact area S is also positioned so as to block part of the outline of the notch portion 12.

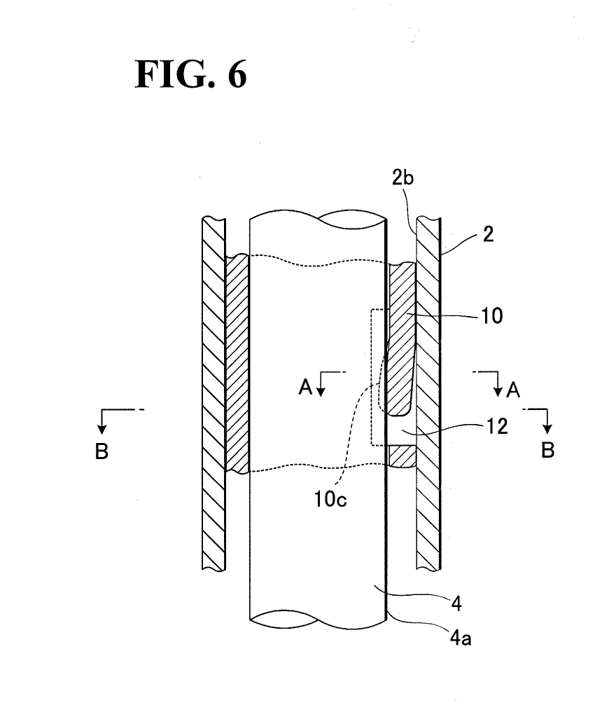

As shown in FIG. 5 to FIG. 8, when the stay 4 is inserted into the stay insertion hole 7 of the headrest holder 5, the free end portion 10b of the tongue piece 10 is pressed by the stay 4. As a result, the outer surface 10a on the free end portion 10b side of the tongue piece 10 is pressed to the inner wall surface 2b of the support bracket 2 while the contact area S of the tongue piece 10 abuts on the inner wall surface 2b of the support bracket 2. Accordingly, it is possible to prevent the stay 4 from falling off.

In the headrest holder 5 having the above structure, the tongue piece 10 is elastically pressed onto the outer peripheral surface 4a of the stay 4 when the stay 4 of the headrest 3 is inserted into the stay insertion hole 7 formed in the main body 6, therefore, the wobble of the stay 4 of the headrest 3 and generation of the rattle can be prevented.

Additionally, the outer surface 10a on the base end side of the tongue piece 10 has the contact area S making the surface contact with the inner wall surface 2b of the support bracket 2, therefore, the bending stress generated on the base end side of the tongue piece 10 when the tongue piece 10 is elastically pressed to the outer peripheral surface 4a of the stay 4 can be dispersed by the contact area S, which prevents stress concentration to the base end side of the tongue piece 10.

There is a danger that the elasticity of the tongue piece 10 is reduced and is finally broken when the stress is concentrated. However, the durability of the tongue piece 10 required when the stay 4 of the headrest 3 is inserted into and pulled out from the headrest holder 5 can be also increased by applying the tongue piece 10 having the contact area S.

While having described the present invention thus far, it is to be understood that the invention is not limited to the illustrated embodiment, but any modification, addition and replacement may be applied thereto, without departing from the scopes of the appended claims.

1. A holder for headrest for a support bracket in a top portion of a seat back of a seat in a vehicle, the holder comprising:
a main body loaded in the support bracket and having a stay insertion hole for receiving a stay of a headrest,
wherein the main body comprises an elastic tongue piece hanging downward, the tongue piece comprising:
a base end mounted to the main body,
a free end positioned remote from the base end in a longitudinal direction of the tongue piece,
a free portion comprising the free end and protruding into the stay insertion hole, and
an outer surface extending in the longitudinal direction of the tongue piece between the base end and the free end, the outer surface comprising a contact area adjacent the base end, the contact area making surface contact with an inner wall surface of the support bracket; and
the main body is loaded inside the support bracket so that the free portion of the tongue piece is separated from the inner wall surface of the support bracket.

2. The holder for headrest according to claim 1, wherein the tongue piece is arranged on a rear side of the main body in a circumferential direction of the main body.

3. The holder for headrest according to claim 1, wherein the holder comprises a plurality of tongue pieces formed in the main body, the tongue pieces arranged in a longitudinal direction of the stay insertion hole.

4. The holder for headrest according to claim 1, wherein the free portion of the tongue piece comprises a stay abutting surface having a curved shape and fitted to an outer peripheral surface of the stay.

5. The holder for headrest according to claim 1, wherein the main body comprises a notch portion positioned and configured to allow the tongue piece to protrude into the stay insertion hole.

6. The holder for headrest according to claim 1, wherein the support bracket comprises a holder loading hole for loading the main body,
the inner wall surface forming the holder loading hole has a rectangular shape in cross section, and
the contact area is formed as a flat surface for making the surface contact with the inner wall surface.

7. The holder for headrest according to claim 1, wherein the tongue piece is made of resin and deforms around the base end side of the tongue piece in a state in which the contact area abuts the inner wall surface of the support bracket.

8. The holder for headrest according to claim 1, wherein a lower end of the main body comprises a lock piece locked in the support bracket is provided.

9. The holder for headrest according to claim 1, wherein the outer wall surface of the main body comprises a plurality of ribs abutting the inner wall surface of the support bracket, the ribs having a length extending in a circumferential direction of the outer wall surface of the main body, and
the plurality of ribs is positioned such that the ribs are arrayed in the main body in a lengthwise direction of the stay insertion hole.

10. A vehicle seat comprising the holder of claim 1.

11. A vehicle comprising a vehicle seat comprising the holder of claim 1.
